(19) United States
(12) Patent Application Publication
(10) Pub. No.: US 2023/0294617 A1
(43) Pub. Date: Sep. 21, 2023

(54) DOOR ASSEMBLY OF A VEHICLE DOOR

(71) Applicant: Brose Fahrzeugteile SE & Co. Kommandilgesellschaft, Bamberg, Bamberg (DE)

(72) Inventors: Christian Salm, Bamberg (DE); Jürgen Knorr, Weidhausen (DE); Klaus Hampel, Coburg (DE)

(21) Appl. No.: 18/013,646

(22) PCT Filed: Jun. 24, 2021
(86) PCT No.: PCT/EP2021/067318

§ 371 Date: Apr. 11, 2023

(30) Foreign Application Priority Data
Jun. 29, 2020 (DE) 10 2020 208 028.3

(51) Int. Cl. B60R 13/02; B60J 5/04

(52) U.S. Cl. CPC B60R 13/0206; B60J 5/0416; B60R 13/0243; F16B 21/073

(57) ABSTRACT

A door assembly of a vehicle door includes a frame, a door module fastened to the frame, and a door lining fastened to the door module. The door lining includes at least one fastening element. The door module has a support plate which, at least in some sections, is made from a plastic material and which has a fastening device integrally formed thereon in the region of the plastic material. The fastening device is provided to enable the non-destructive fastening of the fastening element.

The invention relates to a door assembly of a vehicle door, comprising a door frame and a door module and a door trim. The invention also relates to a vehicle door of a motor vehicle comprising such a door assembly.

The functional components of a vehicle door, for example window regulator, drive device, side airbag module, speaker, operator control unit or the like, are generally preassembled on a carrier plate of a door module, also referred to as a door module carrier or assembly carrier. The door module or the carrier plate is in this case installed in a door aperture of a door frame or of a door bodyshell of the vehicle door. The door frame comprises by way of example a door outer panel and a door inner panel.

In order to cover the door module and the door frame in particular on the vehicle inner side, provision is typically made of a door interior trim which is fastened to fastening points of the door frame. To this end, provision is for example made of ball studs as fastening elements, which are fastened to the door inner panel of the door frame by means of a clinched connection, that is to say by means of clinching. The door interior trim is subsequently fixed to the door frame via the ball studs by means of an inserted clip.

Due to the frame-side fastening points, the door aperture for the door module is reduced, with the result that the installation space for the door module—and thus for the functional components—is disadvantageously restricted.

The invention is based on the object of specifying a particularly suitable door assembly for a vehicle door. In particular, the installation space for the door module is intended to be enlarged. The invention is also based on the object of specifying a particularly suitable vehicle door.

The object is achieved according to the invention, with regard to the door assembly, by means of the features of claim 1, and, with regard to the vehicle door, by means of the features of claim 10. The dependent claims provide advantageous configurations and refinements. The advantages and configurations mentioned with respect to the door assembly can also be applied analogously to the vehicle door and vice versa.

The door assembly according to the invention is provided for a vehicle door, for example for a side door of a motor vehicle, and is suited and configured therefor. In this case, the door assembly comprises a door frame as door bodyshell with a door outer panel and a door inner panel, wherein a door module is fastened to the door frame. A door trim, in particular a door interior trim, is fastened to the door module.

The door trim comprises at least one for example projecting or recessed fastening element. The door module comprises a carrier plate which is produced at least in certain portions from a plastics material. In the region of the plastics material, an in particular integrally formed fastening element, that is to say formed in one part or monolithically, is provided for a destruction-free fastening of the fastening element. Due to the integral arrangement of the fastening apparatus on the carrier plate, a particularly stable and fail-safe fastening for the fastening element is realized.

This means that the fastening point for the door trim is arranged not on the door frame but on the door module. In other words, the fastening point is shifted to, or integrated into, the door module. The integration of the fastening apparatus of the door trim into the plastics material of the carrier plate realizes an advantageous functional integration which advantageously reduces the complexity of the joining connection, the number of parts and the number of assembly steps. In particular, separate clips for fixing of the fastening elements are thus omitted. This advantageously reduces the production costs of the door assembly. Furthermore, the fastening points on the door frame are thus omitted, as a result of which a door aperture for the door module or for the carrier plate can be dimensioned to be larger, with the result that additional freedoms and flexibilities with regard to the assembly and fitting of the door module are realized. In particular, an additional weight potential of the door assembly is produced.

Here and in the following text, a door frame should be understood to mean both a door bodyshell with a frame around the window pane, and a door bodyshell for a frameless vehicle door, that is to say without a frame around the window pane.

Here, “produced in certain portions from a plastics material” should be understood in particular to mean that at least one part of the carrier plate or multiple parts of the carrier plate are produced from a plastics material. Preferably, a large part of the carrier plate, that is to say more than 40% or 50% of the carrier plate, and in particular a supporting surface or assembly surface, defined by the carrier plate, for the arrangement of functional components, is formed from the plastics material. By way of example, the plastics material used is a fiber-reinforced plastic, preferably a long glass fiber-reinforced polypropylene (PP-LGF), in particular PP-LGF 30 having a glass fiber proportion of 30%.

The door trim comprises at least one fastening element and the door module comprises at least one corresponding fastening apparatus. A number of fastening elements and fastening apparatuses which are arranged distributed on the door trim and the carrier plate, respectively, are advantageously provided. This ensures a particularly secure and reliable hold of the door trim.

By way of example, the door trim is fastened partially to the door module and partially to a door inner panel of the door frame. In an advantageous embodiment, however, the door trim is fastened merely to the fastening apparatus of the door module. This means that the door trim is fastened to the door frame merely indirectly via the door module, and has no direct attachment points to the door frame itself. In this case, the door trim may have, for example, electrical interfaces or the like with respect to the door frame, but the mechanical mounting and fastening of the door trim is effected merely by means of the fastening apparatus of the door module. This ensures that the largest possible door aperture for the door module is realized.

In a suitable refinement, the fastening element is held, at least in certain portions, in the fastening apparatus in a form-fitting and/or force-fitting manner. The fastening element here comprises, for example, a fastening portion, in particular a head portion, which interacts with the fastening apparatus. As a result, a reliable fastening of the door trim to the door module is realized.

Here and in the following text, the conjunction “and/or” should be understood to mean that the features linked by this conjunction may be implemented both jointly and as alternatives with respect to one another.

Here and in the following text, a “form fit” or a “form-fitting connection” between at least two parts which are connected to one another is understood in particular to mean that the cohesion of the parts which are connected to one another is effected at least in one direction by direct interengagement of contours of the parts themselves or by indirect interengagement via an additional connecting part. The “blocking” of a mutual movement in this direction is thus effected in a manner due to shape.

Here and in the following text, a “force fit” or “force-fitting connection” between at least two parts which are connected to one another is understood in particular to mean that the parts which are connected to one another are prevented from sliding off one another on account of a frictional force which acts between them. If a “connecting force” which brings about this frictional force (this means that force which presses the parts against one another, for example a bolt force or the weight force itself) is absent, the force-fitting connection cannot be maintained and may therefore be released.

For the purpose of a particularly simple fastening with reduced effort, and in particular without tools, the fastening element is plugged into the fastening apparatus. The fastening element is thus plug-connected, as a plug connector, in the fastening apparatus in the form of a plug connector holder or plug socket. In an advantageous configuration, the fastening apparatus in this case comprises at least one stop element for mechanical delimitation of an axial plug-in depth of the fastening element. Here, the axial direction is oriented along the plug-in direction, that is to say substantially perpendicularly with respect to the carrier plate. The stop element in this case bears in particular against an axial end face of the fastening element.

An additional or further aspect of the invention provides at least one resiliently elastic or flexurally elastic latching element of the fastening apparatus, said latching element latching mechanically with the fastening element. As a result, a latching fastening or clip fastening of the fastening element with reduced effort is realized.

The fastening apparatus suitably comprises both a latching element and a stop element. In an advantageous configuration, the fastening element in this case comprises a head portion which bears against the stop element and/or which is engaged behind in an axially form-fitting manner by the latching element. In particular, the head portion is fixed in a clamping manner between the stop element and the latching element. As a result, a particularly stable fastening is realized.

In a preferred embodiment, the fastening apparatus comprises a central receptacle for the head portion, wherein a number of stop elements and/or latching elements protrude radially into the receptacle and bear against the head portion. As a result, a particularly suitable fastening apparatus is realized. An axially form-fitting fastening of the head portion is realized by the stop elements and latching elements, wherein a radially form-fitting mounting is also realized by the number of stop elements and latching elements and their distributed arrangement on the receptacle.

In a suitable refinement, the stop elements are integrally formed at an edge of the receptacle. In other words, the stop elements are integrally formed in the region of the carrier plate, with the result that a high mechanical stability of the stop elements is ensured.

In an advantageous configuration, a respective freestanding connecting bridge, that is to say a connecting bridge which is not connected to the edge of the receptacle, and on which a latching element is integrally formed, extends between two adjacent stop elements. A respective latching element is thus arranged between the stop elements. Latching elements and stop elements therefore alternate along the circumferential direction of the receptacle. As a result, a particularly secure fastening and mounting of the head portion—and thus of the door trim—is realized.

In a preferred application, the above-described door assembly is part of a vehicle door of a motor vehicle, in particular a side door. As a result of the fastening according to the invention of the door trim, in particular the door interior trim, to the door module, a particularly advantageous vehicle door is realized. In particular, the door frame comprises an enlarged door aperture and thus a larger door module.

Exemplary embodiments of the invention will be explained in more detail below on the basis of a drawing, in which:

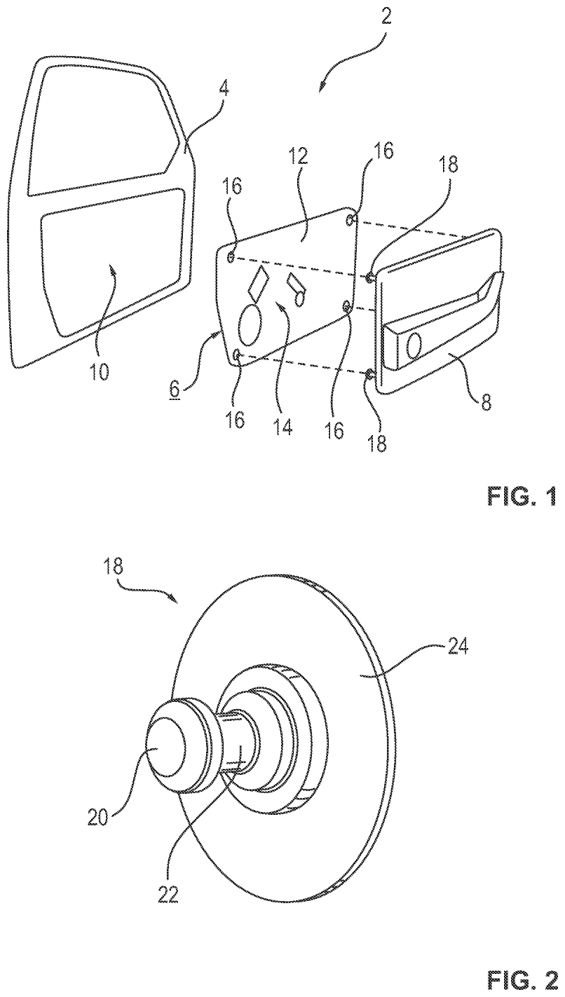

FIG. 1 shows a perspective illustration of a door assembly with a door frame and with a door module and with a door trim,

FIG. 2 shows a perspective illustration of a fastening element of the door trim,

FIG. 3 shows a plan view of the fastening element in a fastening apparatus of the door module, and

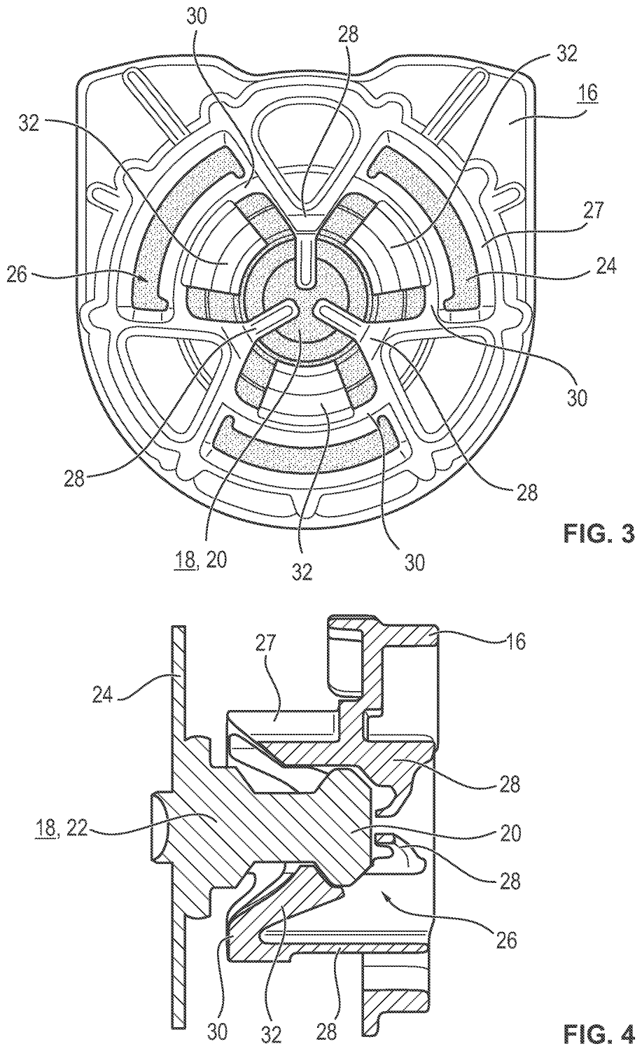

FIG. 4 shows a sectional view of the fastening element and of the fastening apparatus.

Mutually corresponding parts and dimensions are always provided with the same reference designations in all of the figures.

The exploded illustration in FIG. 1 shows a door assembly 2 of a vehicle door in a partially assembled state. The door assembly 2 comprises a door frame 4 and a door module 6 and a door trim 8. In this case, the vehicle door is embodied by way of example as a side door.

In the assembled state of the vehicle door, the door module 6 is joined to the door frame 4, in particular to a door inner panel, in a manner that is not illustrated in any more detail. The door trim 8 is fastened to the door module 6, and is held by way of the latter indirectly on the door frame 4 or on the door inner panel.

The door frame 4 comprises a cutout as door aperture 10 for receiving the door module 6. The door module 6 comprises a carrier plate 12 as assembly carrier or module carrier, on which functional components 14 of the vehicle door are preassembled. The carrier plate 12 is produced at least in certain portions from a plastics material, in particular a fiber composite material, preferably from an organosheet. In this case, the carrier plate 12 comprises, in the corner regions, four fastening apparatuses 16 for the door trim 8 which are formed integrally, that is to say in one part or monolithically, on the plastics regions of the carrier plate 12.

The door trim 8 is embodied as a door interior trim of the vehicle door. Four perpendicularly or axially projecting fastening elements 18, which for the fastening of the door trim 8 are plugged into the fastening apparatuses 16 of the carrier plate 12 in a form-fitting and/or force-fitting manner, are provided on the rear side of the door trim 8, that is to say on a planar side facing away from the passenger compartment or on the planar side facing the door module 6.

The fastening elements 18 illustrated individually in FIG. 2 comprise a head portion 20 and a shank portion 22 adjoining thereto, wherein the shank region 22 is clinched to a disk 24 of the door trim 8. The head portion 20 protrudes radially in relation to the stud-like or cylindrical shank region 22. The fastening element 18 is embodied in particular as a ball rivet stud, wherein the fastening element 18 and the disk 24 are embodied as a clinch rivet-ball rivet stud assembly.

FIGS. 3 and 4 show a joined or fastened state in which the fastening element 18 has been plugged into the fastening apparatus 16.

The fastening apparatus 16 comprises a central receptacle 26 for the fastening element 18. The receptacle 26 comprises a projecting collar or edge 27 on the surface facing the door trim 8. The edge 27 is in the form of an insertion or plug-in aid for the fastening element 18. Three radially inwardly directed tabs are integrally formed as stop elements 28 at the edge 27, said tabs, as mechanical stop for the head portion 20, delimit the axial plug-in depth of the fastening element 18.

A respective freestanding, circular ring segment-shaped connecting bridge 30, on which a respective resiliently elastic or flexurally elastic latching element 32 is integrally formed, is provided between the stop elements 28. The fastening apparatus 16 thus comprises, in addition to the three stop elements 28, three latching elements 32 which are in the form of latching tabs or latching tongues for destruction-free mechanical latching or clip-fastening to the fastening element 18.

As can be seen relatively clearly in the sectional view in FIG. 4, the head portion 20 bears against the end faces of the stop elements 28, wherein the latching elements 32 are clip-fastened to the head portion 20 in such a way that the head portion 20 is held in an axially and radially form-fitting and/or force-fitting manner between the stop elements 28 and the latching elements 32. In this case, the latching elements 32 engage behind the head portion 20, diametrically opposite to a respectively assigned stop element 28, with the result that the fastening element 18 is held in a reliable and fail-safe manner.

The invention is not limited to the exemplary embodiments described above. Rather, other variants of the invention may also be derived therefrom by a person skilled in the art without departing from the subject matter of the invention. In particular, it is furthermore the case that all individual features described in conjunction with the exemplary embodiments may also be combined with one another in some other way without departing from the subject matter of the invention.

### LIST OF REFERENCE DESIGNATIONS

2 Door assembly
4 Door frame
6 Door module
8 Door trim
10 Door aperture
12 Carrier plate
14 Functional component
16 Fastening apparatus
18 Fastening element
20 Head portion
22 Shank portion
24 Disk
26 Receptacle
27 Edge
28 Stop element
30 Connecting bridge
32 Latching element

1-10. (canceled)

11. A door assembly of a vehicle door, comprising:
a frame, a door module fastened to said frame, and a door trim fastened to said door module;
said door trim including at least one fastening element; and
said door module having a carrier plate formed, at least in certain portions, from a plastics material, and having, in a region of said plastics material, a fastening apparatus integrally formed thereon for destruction-free attachment of said fastening element.

12. The door assembly according to claim 11, wherein said door trim is fastened only to said fastening apparatus of said door module.

13. The door assembly according to claim 11, wherein said fastening element is held in said fastening apparatus, at least in certain portions, in at least one of a form-fit or a force-fit.

14. The door assembly according to claim 11, wherein said fastening apparatus comprises at least one stop element for a mechanical delimitation of an axial plug-in depth of said fastening element.

15. The door assembly according to claim 11, wherein said fastening apparatus comprises at least one resiliently elastic latching element for mechanically latching said fastening element.

16. The door assembly according to claim 14, wherein said fastening element comprises a head portion which bears against said stop element and/or which is engaged behind in an axial form-fit by said latching element.

17. The door assembly according to claim 16, wherein said fastening apparatus comprises a central receptacle for said head portion of said fastening element, and wherein a number of stop elements and/or latching elements protrude radially into said receptacle.

18. The door assembly according to claim 17, wherein said at least one stop element is integrally formed at an edge of said receptacle.

19. The door assembly according to claim 17, wherein said at least one stop element is one of a plurality of stop elements integrally formed at an edge of said receptacle.

20. The door assembly according to claim 19, which comprises a respective freestanding connecting bridge, on which a latching element is integrally formed, extending between two adjacent said stop elements.

21. A vehicle door of a motor vehicle, comprising a door assembly according to claim 11.
